(19) United States
(12) Patent Application Publication
(10) Pub. No.: US 2026/0360697 A1
(43) Pub. Date: Nov. 12, 2026

(54) POSITIVE ELECTRODE FOR SECONDARY BATTERY, AND SECONDARY BATTERY

(71) Applicant: Panasonic Energy Co., Ltd., Moriguchi-shi, Osaka (JP)

(72) Inventors: Koki Morita, Osaka (JP); Rintaro Natori, Hyogo (JP); Taiga Fukabori, Tokushima (JP)

(73) Assignee: Panasonic Energy Co., Ltd., Moriguchi-shi, Osaka (JP)

(21) Appl. No.: 19/122,011

(22) PCT Filed: Oct. 5, 2023
(86) PCT No.: PCT/JP2023/036330

§ 371 Date: Apr. 17, 2025

(30) Foreign Application Priority Data
Oct. 31, 2022 (JP) 2022-174972

(51) Int. Cl. H01M 4/131; H01M 4/02; H01M 4/36; H01M 4/505; H01M 4/525

(52) U.S. Cl. CPC H01M 4/131; H01M 4/364; H01M 4/505; H01M 4/525; H01M 2004/021; H01M 2004/028

(57) ABSTRACT

A positive electrode (11), which is an example of an embodiment, comprises a positive electrode core (30) and a positive electrode mixture layer (31) that is disposed on the positive electrode core (30). The positive electrode mixture layer (31) includes a first region (35) and a second region (36) that are alternately disposed in at least one direction from among the length direction and the width direction of the positive electrode core (30). The porosity in the second region (36) is greater than the porosity in the first region (35).

### TECHNICAL FIELD

The present disclosure relates to a positive electrode for a secondary battery and a secondary battery using the positive electrode.

### BACKGROUND ART

Secondary batteries such as lithium-ion batteries are widely used for usage requiring a high capacity, high durability, high-speed charge performance, and the like, such as on-board use and power storage use, in recent years. Since a positive electrode, which is a main constitutional element of the secondary battery, significantly affects these performances, there have been many investigations on the positive electrode. For example, Patent Literature 1 discloses a positive electrode in which physical properties of a mixture layer are set to be different in a thickness direction of the positive electrode mixture layer, and an active material having a large specific area is set to be present at a larger amount on a core side than on a surface side of the mixture layer.

### CITATION LIST

### Patent Literature

PATENT LITERATURE 1: Japanese Patent No. 5929183

### SUMMARY

Patent Literature 1 describes an effect of improving a discharge capacity and cycle characteristics. However, setting the specific surface area of the mixture layer on the surface side to be small is considered to cause insufficient permeation of an electrolyte liquid toward the core side to deteriorate the high-speed charge performance. Particularly when the mixture layer is formed at a high density in order to increase an energy density, the deterioration of the high-speed charge performance becomes more considerable. It is an advantage of the present disclosure to provide a positive electrode that can achieve a secondary battery having a high capacity and excellent high-speed charge performance.

A positive electrode for a secondary battery according to the present disclosure comprises: a positive electrode core; and a positive electrode mixture layer disposed on the positive electrode core, wherein the positive electrode mixture layer includes a first region and a second region that are alternately disposed in at least one direction of a longitudinal direction and a width direction of the positive electrode core, and a porosity of the second region is greater than a porosity of the first region.

A secondary battery according to the present disclosure comprises: the above positive electrode; a negative electrode; and an electrolyte.

According to the positive electrode of the present disclosure, the secondary battery having a high capacity and excellent high-speed charge performance may be provided.

### BRIEF DESCRIPTION OF DRAWING

FIG. 1 is a sectional view of a secondary battery of an example of an embodiment.

FIG. 2 is a front view of a positive electrode of an example of an embodiment.

FIG. 3 is a sectional view along an AA line in FIG. 2.

FIG. 4 is a view illustrating a modified example of the positive electrode.

FIG. 5 is a view illustrating a modified example of the positive electrode.

### DESCRIPTION OF EMBODIMENTS

The present inventors have intensively investigated the above problem, and as a result, successfully achieved the secondary battery having excellent high-speed charge performance while having a high capacity by providing first and second regions with different porosities in a positive electrode mixture layer and by alternately disposing the first and second regions in at least one direction of a longitudinal direction and a width direction of a positive electrode core. A function of the second region with a large porosity remarkably improves permeability of an electrolyte liquid in an entirety of the mixture layer to allow the electrolyte liquid to quickly permeate also in a thickness direction of the mixture layer. As a result, the excellent high-speed charge performance is obtained.

Meanwhile, the first region of the mixture layer with a small porosity contributes to increase in the capacity. Into the first region, the electrolyte liquid is supplied also from the adjacent second region. According to the secondary battery using the positive electrode according to the present disclosure, the high capacity and the excellent high-speed charge performance may be highly achieved. Since the electrolyte liquid is smoothly supplied into the entirety of the mixture layer, uniform battery reactions occur in a wide range of the mixture layer to improve also cycle characteristics.

Hereinafter, an example of embodiments of the positive electrode for a secondary battery according to the present disclosure and the secondary battery using the positive electrode will be described in detail with reference to the drawings. The scope of the present disclosure includes configurations composed of selective combinations of constitutional elements of a plurality of embodiments and modified examples described below.

In the embodiments described below, a cylindrical battery 10 in which a wound electrode assembly 14 is housed in a bottomed cylindrical exterior housing can 16 will be exemplified as the secondary battery, but the exterior body of the battery is not limited to the cylindrical exterior housing can. Examples of other embodiments of the secondary battery according to the present disclosure include a rectangular battery comprising a rectangular exterior housing can, a coin battery comprising a coin-shaped exterior housing can, and a pouch battery comprising an exterior body constituted of laminated sheets including a metal layer and a resin layer. The electrode assembly is not limited to the wound electrode assembly, and may be a stacked electrode assembly in which a plurality of positive electrodes and a plurality of negative electrodes are alternately stacked via a separator. The electrolyte may be an aqueous electrolyte, but a non-aqueous electrolyte is used in the present embodiment.

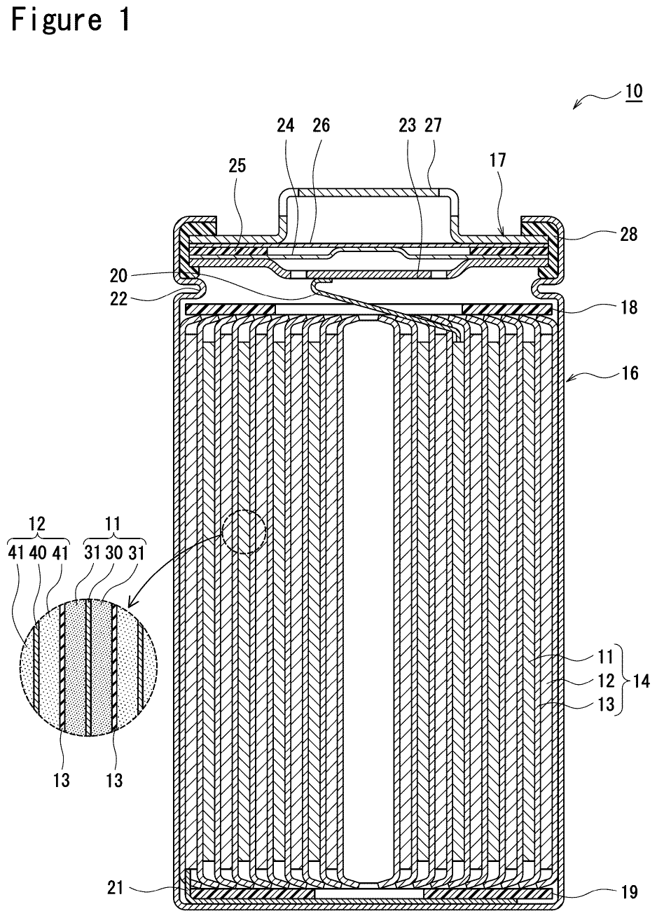

FIG. 1 is a view schematically illustrating an axial cross section of a cylindrical battery 10 of an example of an embodiment. As illustrated in FIG. 1, the cylindrical battery 10 comprises the wound electrode assembly 14, the non-aqueous electrolyte, and the exterior housing can 16 housing the electrode assembly 14 and the non-aqueous electrolyte. The electrode assembly 14 has a positive electrode 11, a negative electrode 12, and a separator 13, and has a wound structure in which the positive electrode 11 and the negative electrode 12 are spirally wound via the separator 13. The exterior housing can 16 is a bottomed cylindrical metallic container opened on one end side in an axial direction, and the opening portion of the exterior housing can 16 is sealed with a sealing assembly 17. Hereinafter, for convenience of description, the sealing assembly 17 side of the battery will be described as the upper side, and the bottom side of the exterior housing can 16 will be described as the lower side.

The non-aqueous electrolyte includes a non-aqueous solvent and an electrolyte salt dissolved in the non-aqueous solvent. For the non-aqueous solvent, esters, ethers, nitriles, amides, and a mixed solvent of greater than or equal to two thereof, and the like are used, for example. An example of the non-aqueous solvent includes ethylene carbonate (EC), ethyl methyl carbonate (EMC), dimethyl carbonate (DMC), diethyl carbonate (DEC), a mixed solvent thereof, and the like. The non-aqueous solvent may contain a halogen-substituted derivative (such as fluoroethylene carbonate, for example) in which hydrogen of these solvents is at least partially replaced with a halogen atom such as fluorine. For the electrolyte salt, a lithium salt such as LiPF₆ is used, for example.

The positive electrode 11, the negative electrode 12, and the separator 13, which constitute the electrode assembly 14, are all a band-shaped elongated body, and spirally wound to be alternately stacked in a radial direction of the electrode assembly 14. To prevent precipitation of lithium, the negative electrode 12 is formed to be one size larger than the positive electrode 11. That is, the negative electrode 12 is formed to be longer than the positive electrode 11 in a longitudinal direction and a width direction. The separator 13 is formed to be one size larger than at least the positive electrode 11, and two of the separators 13 are disposed so as to sandwich the positive electrode 11, for example. The electrode assembly 14 has a positive electrode lead 20 connected to the positive electrode 11 by welding or the like and a negative electrode lead 21 connected to the negative electrode 12 by welding or the like.

Insulating plates 18 and 19 are respectively disposed on the upper and lower sides of the electrode assembly 14. In the example illustrated in FIG. 1, the positive electrode lead 20 extends through a through hole of the insulating plate 18 toward the sealing assembly 17 side, and the negative electrode lead 21 extends through the outside of the insulating plate 19 toward the bottom side of the exterior housing can 16. The positive electrode lead 20 is connected to a lower surface of an internal terminal plate 23 of the sealing assembly 17 by welding or the like, and a cap 27, which is a top plate of the sealing assembly 17 electrically connected to the internal terminal plate 23, becomes a positive electrode terminal. The negative electrode lead 21 is connected to a bottom inner surface of the exterior housing can 16 by welding or the like, and the exterior housing can 16 becomes a negative electrode terminal.

A gasket 28 is provided between the exterior housing can 16 and the sealing assembly 17 to achieve sealability inside the battery. On the exterior housing can 16, a grooved portion 22 in which a part of a side surface portion thereof projects inward to support the sealing assembly 17 is formed. The grooved portion 22 is preferably formed in a circular shape along a circumferential direction of the exterior housing can 16, and supports the sealing assembly 17 with the upper face thereof. The sealing assembly 17 is fixed on the upper part of the exterior housing can 16 with the grooved portion 22 and with an end part of the opening portion of the exterior housing can 16 caulked to the sealing assembly 17.

The sealing assembly 17 has a stacked structure of the internal terminal plate 23, a lower vent member 24, an insulating member 25, an upper vent member 26, and the cap 27 in this order from the electrode assembly 14 side. Each member constituting the sealing assembly 17 has, for example, a disk shape or a ring shape, and each member except for the insulating member 25 is electrically connected to each other. The lower vent member 24 and the upper vent member 26 are connected at each of central parts thereof, and the insulating member 25 is interposed between the circumferential parts of the lower vent member 24 and the upper vent member 26. If the internal pressure of the battery increases due to abnormal beat generation, the lower vent member 24 is deformed so as to push the upper vent member 26 up toward the cap 27 side and breaks, and thereby a current pathway between the lower vent member 24 and the upper vent member 26 is cut off. If the internal pressure further increases, the upper vent member 26 breaks, and gas is discharged through an opening portion of the cap 27.

Hereinafter, the positive electrode 11, the negative electrode 12, and the separator 13, which constitute the electrode assembly 14, specifically the positive electrode 11, will be described in detail.

### [Positive Electrode]

The positive electrode 11 has a positive electrode core 30 and a positive electrode mixture layer 31 disposed on the positive electrode core 30. For the positive electrode core 30, a foil of a metal stable within a potential range of the positive electrode 11, such as aluminum, an aluminum alloy, stainless steel, and titanium, a film in which such a metal is disposed on a surface thereof, and the like may be used. The positive electrode mixture layer 31 includes a positive electrode active material, a conductive agent, and a binder, and preferably provided on both surfaces of the positive electrode core 30 except for a portion where the positive electrode lead 20 is to be connected. Between the positive electrode core 30 and the positive electrode mixture layer 31 or on the positive electrode mixture layer 31, a protective layer including inorganic particles and a binder may be disposed.

The positive electrode 11 may be produced by, for example, applying a positive electrode mixture slurry including the positive electrode active material, the conductive agent, and the binder on the positive electrode core 30, and drying and then compressing the coating film to form the positive electrode mixture layer 31 on both the surfaces of the positive electrode core 30. For a dispersion medium of the positive electrode mixture slurry, N-methyl-2-pyrrolidone (NMP) is used, for example. The positive electrode mixture slurry may be prepared by adding the positive electrode active material into a conductive agent paste including the conductive agent, the binder, and a dispersion medium. The positive electrode mixture slurry and the conductive agent paste may include a dispersant.

Although a detail will be described below, the positive electrode mixture layer 31 includes a first region and a second region that are alternately disposed in at least one direction of a longitudinal direction and a width direction of the positive electrode core 30 and that have physical properties different from each other. The positive electrode mixture layer 31 is formed by using at least two types of the positive electrode mixture slurry.

For the positive electrode active material, a lithium-metal composite oxide is used. Examples of metal elements contained in the lithium-metal composite oxide include Li, Ni, Co, Mn, Al, Be, B, Na, Mg, Si, K, Ca, Sc, Ti, V, Cr, Fe, Cu, Zn, Ga, Sr, Y, Zr, Nb, Mo, In, Sn, Sb, Ba, Ta, W, Pb, and Bi. A preferable lithium-metal composite oxide contains Li, Ni, and Co, and contains at least one of Mn and Al.

The lithium-metal composite oxide has a layered rock-salt structure, for example. Examples of the layered rock-salt structure include a layered rock-salt structure belonging to the space group R-3m and a layered rock-salt structure belonging to the space group C2/m. Among these, the layered rock-salt structure belonging to the space group R-3m is preferable from the viewpoints of increase in the capacity and stability of the crystal structure. Content rates of the elements in the composite oxide may be measured with an inductively coupled plasma atomic emission spectrometer (ICP-AES), an electron probe micro analyzer (EPMA), or an energy dispersive X-ray analyzer (EDX).

In the lithium-metal composite oxide, a proportion of Ni relative to a total number of moles of metal elements excluding Li is preferably greater than or equal to 50 mol %, and more preferably greater than or equal to 80 mol %. Setting the content rate of Ni to be greater than or equal to 50 mol % yields the battery with a high capacity, and the effect by adopting the constitution of the present disclosure becomes more remarkable. The content rate of Ni may be greater than or equal to 85 mol %, and may be greater than or equal to 90 mol % relative to the total number of moles of metal elements excluding Li. An upper limit of the content rate of Ni is 95 mol %, for example.

When the lithium-metal composite oxide contains Co, a content rate of Co is preferably greater than or equal to 1 mol % and less than or equal to 25 mol %, and more preferably greater than or equal to 2 mol % and less than or equal to 7 mol % relative to the total number of moles of metal elements excluding Li. In this case, both high capacity and high durability may be achieved while reducing a material cost. When the lithium-metal composite oxide contains Mn, a content rate of Mn is, for example, greater than or equal to mol % and less than or equal to 20 mol % relative to the total number of moles of metal elements excluding Li. In this case, both high capacity and high durability are easily achieved. When the lithium-metal composite oxide contains Al, a content rate of Al is, for example, greater than or equal to 0.1 mol % and less than or equal to 7 mol % relative to the total number of moles of metal elements excluding Li.

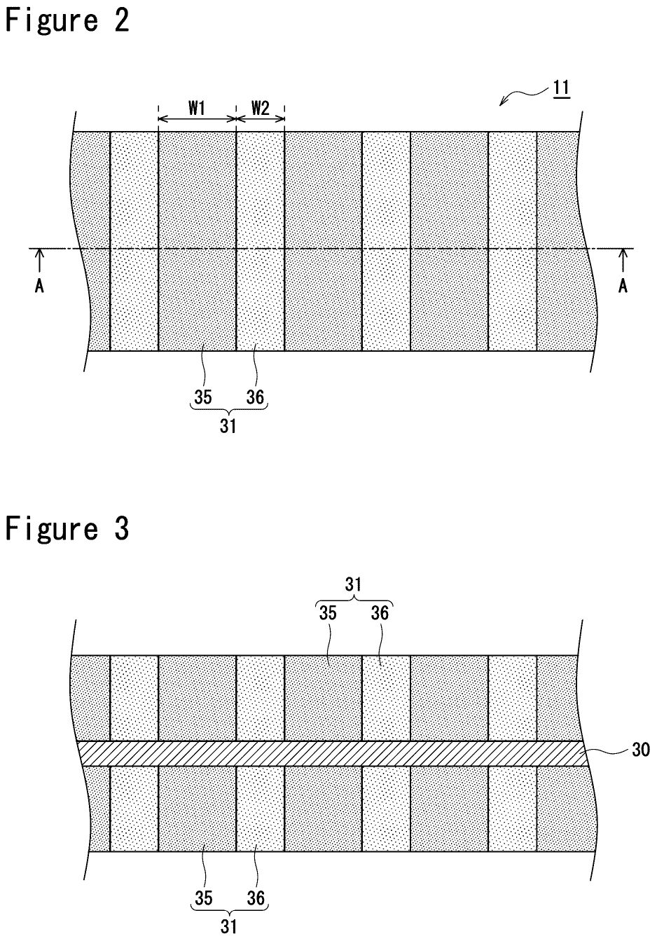

FIG. 2 is a front view of the positive electrode 11, and schematically illustrates an unwound sate of the positive electrode 11. FIG. 3 is a sectional view along the AA line in FIG. 2. As illustrated in FIG. 2 and FIG. 3, the positive electrode mixture layer 31 includes a first region 35 and a second region 36 that are alternately disposed in a longitudinal direction of the positive electrode core 30 (the positive electrode 11). The first region 35 and the second region 36, which are regions having physical properties different from each other, are alternately disposed along the longitudinal direction of the positive electrode core 30 and formed in a stripe shape in a front view of the positive electrode mixture layer 31 (the positive electrode 11) in the present embodiment.

In the positive electrode 11, a porosity of the second region 36 is greater than a porosity of the first region 35. As a result of investigation by the present inventors, it has been found that the cylindrical battery 10 having excellent high-speed charge performance while having a high capacity may be achieved by providing the first region 35 and the second region 36 that have different porosities in the positive electrode mixture layer 31 and alternately disposing the regions in the longitudinal direction of the positive electrode core 30. The first region 35 and the second region 36 may have physical properties other than the porosity different from each other within a range not impairing the object of the present disclosure. In the positive electrode mixture layer, greater than or equal to three regions having different porosities may be present.

The positive electrode 11 remarkably improves the permeability of the electrolyte liquid in the entirety of the mixture layer by the second region 36 having a large porosity, and thereby the excellent high-speed charge performance is obtained. Further, the first region 35 with a small porosity contributes to increase in the capacity. Since the electrolyte liquid is supplied into the first region 35 also from the adjacent second region 36, the positive electrode 11 may highly achieve both high capacity and excellent high-speed charge performance. The second region 36 functions as a supplying path of the electrolyte liquid to smoothly supply the electrolyte liquid toward the entirety of the positive electrode mixture layer 31, and thereby uniform battery reactions occur in the wide range of the positive electrode mixture layer 31 to also improve the cycle characteristics.

BET specific surface areas of the first region 35 and the second region 36 may be, for example, substantially equal, but the BET specific surface area of the second region 36 is preferably set to be greater than the BET specific surface area of the first region 35. The BET specific surface area of each region is measured by a BET method with the mixture layer (each region) peeled from the positive electrode core 30 as a sample and using nitrogen gas, and may be measured with a commercially available measuring device such as HM model-1201, available from Macsorb Corporation, for example.

The BET specific surface area of the second region 36 is preferably greater than or equal to 1.1 times and less than or equal to 3.0 times, and more preferably greater than or equal to 1.2 times and less than or equal to 2.0 times, of the BET specific surface area of the first region 35. For example, the BET specific surface area of the first region 35 is greater than or equal to 1.5 m²/g and less than or equal to 2.5 m²/g, and the BET specific surface area of the second region 36 is greater than or equal to 2.0 m²/g and less than or equal to 3.0 m²/g.

As noted above, the first region 35 and the second region 36 are alternately disposed in the longitudinal direction of the positive electrode core 30, and formed in a stripe shape. A front-viewed shape of the first region 35 and the second region 36 is not particularly limited, and in the example illustrated in FIG. 2, the regions are formed in a front-viewed rectangular shape. A shape and size of each first region 35 may not be the same, but preferably substantially the same from the viewpoints of uniformization of the electrode reactions and the like (the same applies the second region 36). Note that an extent of different shape and size of an extremely small part of the region exhibits the effect similar to the case of the uniform shape and size of the regions.

The first region 35 and the second region 36 may be formed by using positive electrode mixture slurries different from each other, for example. The stripe exemplified in FIG. 2 is formed by: intermittently applying a first positive electrode mixture slurry to form the first region 35 on the surface of the positive electrode core 30 along the longitudinal direction of the positive electrode core 30; and then intermittently applying a second positive electrode mixture slurry to form the second region 36 on portions where the first positive electrode mixture slurry is not applied. The first and second positive electrode mixture slunries may be simultaneously applied on different places of the surface of the positive electrode core 30 to form the stripes. For example, a positive electrode active material to easily provide a small porosity is added into the first positive electrode mixture slurry, and a positive electrode active material to easily provide a large porosity is added into the second positive electrode mixture slurry.

In a plurality of the first regions 35, physical properties such as the porosity are preferably substantially same. Forming each of the first regions 35 using the identical first positive electrode mixture slurry sets the porosity of each of the first regions 35 to be substantially equal. Similarly, in a plurality of the second regions 36, physical properties such as the porosity are preferably substantially same. The porosity is substantially equal in the thickness direction of the first region 35, and for example, the porosity near the positive electrode core 30 in the first region 35 and the porosity near the surface of the first region 35 distanced from the positive electrode core 30 are substantially equal (the same applies the second region 36). Thicknesses of the first region 35 and the second region 36 are preferably the same extent.

A length of the first region 35 along the longitudinal direction of the positive electrode core 30 may be less than or equal to a length of the second region 36 along the longitudinal direction of the positive electrode core 30, but preferably greater than the length of the second region 36. In this case, both the high capacity and the excellent high-speed charge performance may be more highly achieved. In the present embodiment, each of the first region 35 and the second region 36 extends longer in the width direction than the longitudinal direction of the positive electrode core 30.

Hereinafter, the length of the first region 35 along the longitudinal direction of the positive electrode core 30 is referred to as “the width W1”, and the length of the second region 36 along the longitudinal direction of the positive electrode core 30 is referred to as “the width W2”.

The first region 35 and the second region 36 are preferably formed over the entire length in the width direction of the positive electrode core 30. In this case, both the high capacity and the excellent high-speed charge performance may be more highly achieved. The widths W1 and W2 in each region may vary in the width direction of the positive electrode core 30, but in the present embodiment, each region is formed with substantially the same width along the width direction of the positive electrode core 30. The width W1 of each of the first regions 35 is substantially equal, and the width W2 of each of the second regions 36 is substantially equal, and thereby the first region 35 and the second region 36 are regularly repeated to form the stripe in the longitudinal direction of the positive electrode core 30.

The width W1 of the first region 35 is greater than or equal to 1.1 times, more preferably greater than or equal to 1.5 times, and particularly preferably greater than or equal to 2.0 times or greater than or equal to 2.5 times of the width W2 of the second region 36. An upper limit of a ratio (W1/W2) of the width W1 to the width W2 is not particularly limited, and an example thereof is 10.0 times, 9.0 times, or 8.0 times. An example of the preferable range of the ratio (W1/W2) is greater than or equal to 1.1 times and less than or equal to 10.0 times, greater than or equal to 1.5 times and less than or equal to 9.0 times, greater than or equal to 1.5 times and less than or equal to 8.0 times, or greater than or equal to 2.0 times and less than or equal to 8.0 times. Although the preferable ratio (W1/W2) varies depending on the porosity and the like of each region, the ratio (W1/W2) approximately within the above range may more highly achieve both the high capacity and the excellent high-speed charge performance.

The width W1 of the first region 35 is, for example, greater than or equal to 1 mm and less than or equal to 30 mm, and more preferably greater than or equal to 2 mm and less than or equal to 20 mm. The width W2 of the second region 36 is, for example, greater than or equal to 0.5 mm and less than or equal to 20 mm, and more preferably greater than or equal to 1 mm and less than or equal to 15 mm. Although varying depending on the size of the cylindrical battery 10 and the like, a length of the positive electrode 11 is greater than or equal to 40 mm and less than or equal to 4000 mm as an example. In this case, greater than or equal to 1 and less than or equal to 2000 of the first region 35 and the second region 36 are disposed in the longitudinal direction of the positive electrode 11 on one side of the positive electrode core 30, for example. The numbers of the first regions 35 and the second regions 36 aligned in the longitudinal direction of the positive electrode 11 are determined from the widths W1 and W2, and the length of the positive electrode 11.

The porosity of the positive electrode mixture layer 31 contributes to achievement of both the increase in capacity and the excellent high-speed charge performance as long as the porosity satisfies the requirement of the porosity of the second region 36>the porosity of the first region 35, but a lower limit of the porosity of each region is preferably greater than 11%, and more preferably greater than 12%. That is, the porosity of the first region 35 is preferably greater than 11%. An upper limit of the porosity of each region is preferably 35%, and more preferably 30%. That is, the requirement of the porosity of the second region 36>the porosity of the first region 35 is preferably satisfied within the range that the porosity is greater than or equal to 10% and less than or equal to 35%.

The porosity of the first region 35 is preferably greater than or equal to 10% and less than or equal to 30%, more preferably greater than or equal to 12% and less than or equal to 25%, and particularly preferably greater than or equal to 15% and less than or equal to 20%. The porosity of the second region 36 is preferably greater than or equal to 15% and less than or equal to 35%, more preferably greater than or equal to 17% and less than or equal to 30%, and particularly preferably greater than or equal to 20% and less than or equal to 25%. The porosity of each region within the above range and the ratio (W1/W2) within the above range may more highly achieve both the high capacity and the excellent high-speed charge performance.

The porosities of the first region 35 and the second region 36 may be measured by the following method.
(1) A cross section of the positive electrode mixture layer 31 is exposed by using an ion-milling apparatus.
(2) By using a scanning electron microscope (SEM), a backscattered electron image of the exposed cross section of the positive electrode mixture layer 31 is photographed. The magnification with photographing the backscattered electron image is, for example, greater than or equal to 1000 and less than or equal to 5000.
(3) The SEM image of the cross section of the positive electrode mixture layer 31 is imported into a computer, and color-coded into three colors by using an image analysis software (for example, ImageJ, available from National Institutes of Health). The medium color is specified as the pores.
(4) A measurement target region is selected from the processed image, a total area of pores in this region is determined, and a rate of the pores in the measurement target region (the porosity) is calculated.

The porosities of the first region 35 and the second region 36 can be regulated within the target range by, for example, using the same material and changing a compressive force of each region, or can be regulated within the target range by using materials different from each other to form each region. Specifically, at least one selected from the group consisting of the positive electrode active material, the conductive agent, and the binder is changed in the first region 35 and the second region 36. Among these, setting a type of the positive electrode active material to be different in the first region 35 and the second region 36 is preferable from the viewpoints of battery performance, productivity, and the like. In the first region 35 and the second region 36, different positive electrode active materials may be used and the compressive force for the coating film may be set to be different.

The positive electrode mixture layer 31 includes, for example: a first lithium-metal composite oxide being of secondary particles each formed by aggregation of primary particles having an average particle diameter of greater than or equal to 50 μm and less than or equal to 5 μm; and a second lithium-metal composite oxide being of non-aggregated particles, as the positive electrode active material. The first lithium-metal composite oxide includes a large number of the primary particles. The second lithium-metal composite oxide may be of single primary particles (single crystal particles having no particle boundary thereinside) or secondary particles each formed by aggregation of less than or equal to five primary particles. The second lithium-metal composite oxide has a feature of a small number of the primary particles and the particles being hard compared with the first lithium-metal composite oxide. The first lithium-metal composite oxide is, for example, easily crushed in a compressing step of the positive electrode mixture layer 31, and filled at a high density.

The first region 35 includes, for example, a larger amount of the first lithium-metal composite oxide than the second lithium-metal composite oxide. That is, in the first region 35, a content rate (a mass proportion) of the first lithium-metal composite oxide relative to a total mass of the positive electrode active material is greater than a content rate of the second lithium-metal composite oxide. On the other hand, the second region 36 includes a larger amount of the second lithium-metal composite oxide than the first lithium-metal composite oxide, for example. As the positive electrode active material, the first region 35 may include only the first lithium-metal composite oxide, and the second region 36 may include only the second lithium-metal composite oxide.

A volume-based median diameter (hereinafter, which may be referred to as “D50”) of the lithium-metal composite oxide included in the first region 35 is, for example, greater than or equal to 7 μm and less than or equal to 30 μm. The D50 herein means a particle diameter at which a cumulative frequency is 50% from a smaller particle diameter side in volume-based particle size distribution. D50 of the lithium-metal composite oxide included in the second region 36 is, for example, greater than or equal to 1 μm and less than or equal to 10 μm. When the first region 35 includes only the first lithium-metal composite oxide, D50 of the first lithium-metal composite oxide is equal to D50 of the lithium-metal composite oxide included in the first region 35.

The particle size distribution of the positive electrode active material may be measured by using a laser diffraction-type particle size distribution measuring device (for example, MT3000II, manufactured by MicrotracBEL Corp.) with water as a dispersion medium. The average particle diameter of the positive electrode active material may also be determined by measuring diameters of circumscribed circles of particles in a cross-sectional image of the positive electrode mixture layer 31. If it is difficult to measure the above particle size distribution, this average particle diameter may be applied instead of D50. The cross section of the positive electrode mixture layer 31 may be produced by a cross polisher (CP) method, and the cross-sectional image is photographed with an SEM. The average particle diameter may be calculated by averaging particle diameters of random 100 particles in the SEM image.

The average particle diameter of the primary particles constituting the positive electrode active material (the lithium-metal composite oxide) is, for example, greater than or equal to 50 μm and less than or equal to 5.0 μm, and preferably greater than or equal to 50 mm and less than or equal to 1.0 μm. The average particle diameter of the primary particles is calculated by measuring diameters of 100 circumscribed circles of primary particles extracted by analyzing the SEM image of the cross section of the secondary particles, and averaging the measurement values.

The first region 35 may include, for example, two types of the lithium-metal composite oxide having different D50 as the positive electrode active material. Mixing and using the large particles and the small particles increases a filling density of the positive electrode active material to reduce the porosity of the first region 35. In this case, the lithium-metal composite oxide included in the first region 35 has particle size distribution having two peaks. On the other hand, the second region 36 includes, for example, one type of the lithium-metal composite oxide. In this case, the lithium-metal composite oxide included in the second region 36 has particle size distribution having one peak. Note that combination of the positive electrode active material used in each region is not particularly limited as long as the porosities of the first region 35 and the second region 36 may be regulated within the target ranges.

The lithium-metal composite oxide may be synthesized by, for example, mixing and calcining: a composite oxide raw material containing Ni and Co, and containing at least one of Mn and Al; and a Li raw material such as lithium hydroxide (LiOH). The calcined product may be crushed, classified, and the like, and may be washed with water. The composite oxide raw material containing Ni, Co, and the like is obtained by, for example, precipitating (coprecipitating) a composite hydroxide containing Ni, Co, and the like, and thermally treating this composite hydroxide.

The composite hydroxide may be synthesized by, for example, while stirring a solution of metal salts including Ni, Co, and the like, adding a solution of an alkali such as sodium hydroxide dropwise to adjust a pH on the alkaline side (for example, greater than or equal to 8.5 and less than or equal to 12.5). A particle diameter of the composite hydroxide tends to be smaller with a higher pH during the synthesis, and may be controlled by regulating an amount of the solution of the added metal salts. The lithium-metal composite oxides having different particle diameters may be separately produced by controlling the particle diameter of the composite hydroxide.

A step of calcining a mixture of the composite oxide raw material and the Li raw material may be a multi-stage calcining step including a first calcining step and a second calcining step at a temperature higher than in the first calcining step. The mixture is calcined under an oxygen atmosphere, and in this time, an oxygen concentration is set to be greater than or equal to 85%, for example. A preferable first calcining temperature is, although slightly varying depending on composition of the mixture, greater than or equal to 500 °C and less than or equal to 750 °C as an example. A preferable second calcining temperature is greater than or equal to 800 °C and less than or equal to 1150 °C, for example. The temperatures in the calcining steps preferably have a difference of greater than or equal to 50 °C.

Non-aggregated single particles may be synthesized by setting the pH of the alkaline aqueous solution used for synthesizing the composite hydroxide to be higher than that in the case of synthesis of the secondary particles each formed by aggregation of a large number of primary particles, for example. Alternatively, the non-aggregated single particles may be synthesized by setting the calcining temperature to be higher instead of or in addition to setting the pH of the alkaline aqueous solution to be higher. An example of the preferable pH of the alkaline aqueous solution in synthesizing the single particles is greater than or equal to 10 and less than or equal to 11, and a preferable example of the calcining temperature is greater than or equal to 950 °C and less than or equal to 1100 °C. For synthesizing the secondary particles, for example, an alkaline aqueous solution having a pH of greater than or equal to 9 and less than or equal to 10 is used, and the calcining temperature is set to be less than or equal to 950 °C.

Examples of the conductive agent included in the positive electrode mixture layer 31 may include carbon black such as acetylene black and Ketjenblack, graphite, carbon nanotube (CNT), carbon nanofiber, graphene, metal fiber, metal powder, and conductive whisker. The conductive agents may be used singly, or may be used in combinations of a plurality thereof. For example, the first region 35 and the second region 36 include the same type of the conductive agent but may include different conductive agents.

Examples of the binder included in the positive electrode mixture layer 31 may include fluorine-containing resins such as polytetrafluoroethylene (PTFE) and polyvinylidene fluoride (PVDF), olefin resins such as polyethylene, polypropylene, ethylene-propylene-isoprene copolymer, and ethylene-propylene-butadiene copolymer, polyacrylonitrile (PAN), a polyimide, a polyamide, and acrylic resins such as ethylene-acrylic acid copolymer. With these resins, carboxymethylcellulose (CMC) or a salt thereof, polyethylene oxide (PEO), and the like may be used in combination. The binders may be used singly, or may be used in combinations of a plurality thereof. For example, the first region 35 and the second region 36 include the same type of the binder but may include different binders.

Content rates of the conductive agent and the binder are, for example, each greater than or equal to 0.1 mass % and less than or equal to 5 mass % relative to a mass of the positive electrode mixture layer 31. The amounts of the conductive agent in the first region 35 and the second region 36 are substantially equal, for example, but the content rates of the conductive agent may be different in each region. An example thereof includes a case where the content rate of the conductive agent in the second region 36 is set to be greater than the content rate of conductive agent in the first region 35. Similarly, as for the binder, the amounts of the binder in each region are substantially equal, for example, but the content rates of the binder may be different in each region.

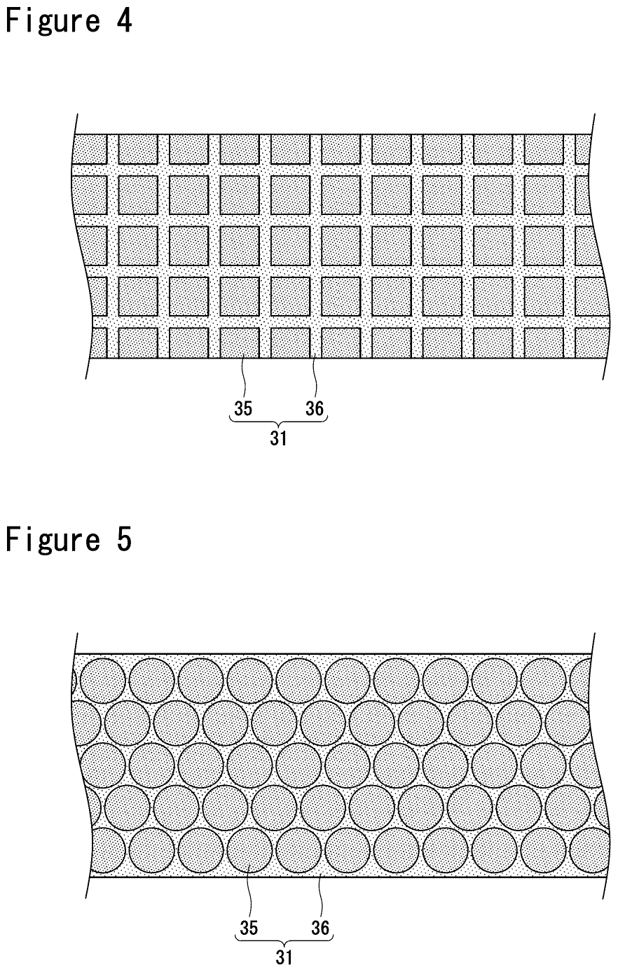

FIG. 4 and FIG. 5 are front views illustrating modified examples of the positive electrode 11. In the example illustrated in FIG. 2, the first region 35 and the second region 36 are alternately disposed along only the longitudinal direction of the positive electrode core 30, but as illustrated in FIG. 4 and FIG. 5, the first region 35 and the second region 36 may be alternately disposed in both directions of the longitudinal direction and the width direction of the positive electrode core 30. The first region 35 and the second region 36 may be disposed with a random and irregular pattern, but are preferably disposed with a regular pattern from the viewpoints of stabilizing the battery performance, uniformizing the battery reaction, and the like.

Note that the first region 35 and the second region 36 may be alternately disposed along only the width direction of the positive electrode 11, but in the case of the stripe shape, the shape exemplified in FIG. 2 is preferable. In the cylindrical battery 10, large change in volume of the electrode assembly 14 with charge and discharge may force out the electrolyte liquid in the axial direction of the electrode assembly 14. Thus, the stripe shape in which the second region 36 having the high porosity and the good permeability of the electrolyte liquid is formed along the axial direction allows supply of the electrolyte liquid toward the electrode assembly 14 to be smoother.

As illustrated in FIG. 4, the second region 36 may be disposed in a lattice shape in a front view of the positive electrode 11. In the example illustrated in FIG. 4, the lattice of the second region 36 is along the width direction and the longitudinal direction of the positive electrode 11, but the lattice may be formed along a direction tilted to the width direction and the longitudinal direction. The first region 35 surrounded by the lattice of the second region 36 has a front-viewed square shape, but may be a rectangular shape. In this case, the second region 36 in the lattice shape also functions as the supplying path of the electrolyte liquid, and a part of the electrolyte liquid is supplied toward the first region 35 through the second region 36.

As illustrated in FIG. 5, the first region 35 may be disposed in a dot shape in a front view of the positive electrode 11. The first region 35 has, for example, a front-viewed true circle shape. In the example illustrated in FIG. 5, each of the first regions 35 has the size same as each other, and disposed in the longitudinal direction of the positive electrode 11 with an equal interval. In the width direction of the positive electrode 11, the first regions 35 are densely disposed so that depression of the dots between two of the first regions 35 is filled with the dot. The second region 36 is formed so as to fill the gap between the dots of the first regions 35. In this case, the second region 36 also functions as the supplying path of the electrolyte liquid.

Note that the second region 36 may be formed in a honeycomb shape (a hexagonal shape) in a front view of the positive electrode 11, or may have a shape other than the circular shape, the quadrangular shape, and the hexagonal shape. The first region 35 may also be formed in a lattice shape or a honeycomb shape, or the second region 36 may be formed in a dot shape.

### [Negative Electrode]

As illustrated in FIG. 1, the negative electrode 12 has a negative electrode core 40 and a negative electrode mixture layer 41 disposed on the negative electrode core 40. For the negative electrode core 40, a foil of a metal stable within a potential range of the negative electrode 12, such as copper, a copper alloy, stainless steel, nickel, and a nickel alloy, a film in which such a metal is disposed on a surface thereof, and the like may be used. The negative electrode mixture layer 41 includes a negative electrode active material and a binder, and preferably provided on both surfaces of the negative electrode core 40 except for a portion where the negative electrode lead 21 is to be connected. Between the negative electrode core 40 and the negative electrode core 40 or on the negative electrode mixture layer 41, a protective layer including inorganic particles and a binder may be disposed.

The negative electrode 12 may be produced by, for example, applying a negative electrode mixture slurry including the negative electrode active material and the binder on the surfaces of the negative electrode core 40, and drying and then compressing the coating film to form the negative electrode mixture layer 41 on both the surfaces of the negative electrode core 40. For a dispersion medium of the negative electrode mixture slurry, water is used, for example. The negative electrode mixture layer 41 may include a conductive agent such as CNT, and for the conductive agent, a conductive agent same as in the case of the positive electrode 11 may be used. The negative electrode mixture slurry may include a dispersant.

For the negative electrode active material, a carbon material that reversibly occludes and releases lithium ions is typically used. For the negative electrode active material, an element that forms an alloy with Li, such as Si and Sn, a material containing this element, and the like may be used. Among these, a material containing Si is preferable. As the negative electrode active material, lithium titanate, which has higher potential of charge and discharge relative to metal lithium than the carbon material and the like, may also be used. The negative electrode active materials may be used singly, or may be used in combinations of a plurality thereof.

The carbon material to function as the negative electrode active material is at least one selected from the group consisting of natural graphite, artificial graphite, soft carbon, and hard carbon, for example. Among these, at least artificial graphite such as massive artificial graphite (MAG) and graphitized mesophase carbon microbead (MCMB), natural graphite such as flake graphite, massive graphite, and amorphous graphite, or a mixture thereof is preferably used as the carbon material. A volume-based D50 of the carbon material is, for example, greater than or equal to 1 μm and less than or equal to 30 μm, and preferably greater than or equal to 5 μm and less than or equal to 25 μm.

An example of the silicon-containing material to function as the negative electrode active material include a silicon alloy, a silicon compound, and a composite material containing Si. Among these, the composite material containing Si is preferable. A preferable composite material is of composite particles including an ion-conductive phase and Si phases dispersed in the ion-conductive phase. The ion-conductive phase is at least one selected from the group consisting of a silicate phase, a carbon phase, a silicide phase, and a silicon oxide phase, for example. The Si phases are formed by dispersing Si as fine particles. The ion-conductive phase is a continuous phase constituted by aggregation of particles finer than the Si phase. A volume-based D50 of the silicon-containing material is, for example, greater than or equal to 1 μm and less than or equal to 20 μm, or greater than or equal to 1 μm and less than or equal to 15 μm.

For the binder included in the negative electrode mixture layer 41, a fluororesin, an olefin resin, PAN, a polyimide, a polyamide, an acrylic resin, or the like may be used as in the case of the positive electrode 11, but polyvinyl acetate, styrene-butadiene rubber (SBR), or the like is typically used. Among these, SBR is preferably used. The binders may be used singly, or may be used in combinations of a plurality thereof. The negative electrode mixture layer 41 preferably includes CMC or a salt thereof, polyacrylic acid (PAA) or a salt thereof, polyvinyl alcohol (PVA), or the like. These function also as a thickener in the negative electrode mixture slurry.

### [Separator]

For the separator 13, a porous sheet having an ion permeation property and an insulation property is used. Specific examples of the porous sheet include a microporous thin film, a woven fabric, and a nonwoven fabric. As a material for the separator 13, a polyolefin such as polyethylene and polypropylene, cellulose, or the like is preferable. The separator 13 may have a single-layered structure or a multi-layered structure. The separator 13 may have, for example, a multi-layered structure including a thermoplastic resin layer such as a polyolefin and a cellulose fiber layer, a bilayer structure of polyethylene (PE)/polypropylene (PP), or a three-layered structure of PE/PP/PE.

On an interface between the separator 13 and at least one of the positive electrode 11 and the negative electrode 12, a filler layer including an inorganic filler may be disposed. Examples of the inorganic filler include oxides containing a metal element such as Ti, Al, Si, and Mg, and a phosphoric acid compound. The filler layer may be formed by applying a slurry containing the filler on the surface of the positive electrode 11, the negative electrode 12, or the separator 13. On the surface of the separator 13, a highly heat-resistant resin layer (a heat-resistant layer) such as an aramid resin may be disposed. The separator 13 may have, for example: a substrate composed of the porous sheet; and the filler layer or the heat-resistant layer disposed on the substrate.

### EXAMPLES

Hereinafter, the present disclosure will be further described with Examples, but the present disclosure is not limited to these Examples.

### Example 1

### [Synthesis of First Lithium-Metal Composite Oxide]

A composite hydroxide containing Ni, Co, and Al at a mole ratio of 85:10:5 was synthesized by a coprecipitation method, and thermally treated at 600 °C to obtain a composite oxide. In the synthesis of the composite hydroxide, a pH and an amount of a solution of metal salts were adjusted so that D50 of a finally obtained lithium-metal composite oxide was about greater than or equal to 15 μm and less than or equal to 20 μm.

The obtained composite oxide and lithium hydroxide were mixed so that a mole ratio (a Li/Me ratio) between the metal elements (Me) in the composite oxide and Li of lithium hydroxide was 1:1.020. This mixture was fed into a calcining furnace to perform a two-step calcining.

In the calcining step, the temperature was raised under an oxygen flow with an oxygen concentration of 95% (a flow rate of 2 mL/min per 10 cm³ and 5 L/min per kilogram of the mixture) at a temperature-raising rate of 3 °C/min (a first temperature-raising rate) from room temperature to 650 °C (a first calcining temperature). Thereafter, the temperature was raised at a temperature-raising rate of 1 °C/min (a second temperature-raising rate) from 650 °C to 750 °C (a second calcining temperature), and held at 750 °C for 3 hours. The calcined product was crushed, and then washed with water to obtain a first lithium-metal composite oxide.

A volume-based D50 of the first lithium-metal composite oxide, measured by using MT3000II manufactured by MicrotracBEL Corp. with water as a dispersion medium, was 17 μm. From an SEM image, this composite oxide was confirmed to be of secondary particles each formed by aggregation of primary particles having an average particle diameter of 500 nm.

### [Preparation of First Positive Electrode Mixture Slurry]

The above first lithium-metal composite oxide was used as a positive electrode active material. The positive electrode active material, acetylene black, and polyvinylidene fluoride (PVdF) were mixed at a solid-content mass ratio of 98:1:1, and N-methyl-2-pyrrolidone (NMP) was used as a dispersion medium to prepare a first positive electrode mixture slurry.

### [Synthesis of Second Lithium-Metal Composite Oxide]

A second lithium-metal composite oxide was obtained in the same manner as of the first lithium-metal composite oxide except that: the pH and the amount of the solution of the metal salts in the synthesis of the composite hydroxide were adjusted so that D50 of a finally obtained lithium-metal composite oxide was about greater than or equal to 1 μm and less than or equal to 5 μm; and KOH at an amount of 10 mass % was added into the composite oxide calcined in the two steps, and the calcining was performed in the oxygen flow at 750 °C for 40 hours.

A volume-based D50 of the second lithium-metal composite oxide, measured by using MT3000II manufactured by MicrotracBEL Corp. with water as a dispersion medium, was 3 μm. From an SEM image, this composite oxide was confirmed to be of non-aggregated single particles constituted of single primary particle or less than or equal to five primary particles.

### [Preparation of Second Positive Electrode Mixture Slurry]

A second positive electrode mixture slurry was prepared in the same manner as of the first positive electrode mixture slurry except that the above second lithium-metal composite oxide was used as the positive electrode active material.

### [Production of Positive Electrode]

The first positive electrode mixture slurry was intermittently applied on both surfaces of a positive electrode core composed of aluminum foil to form a first coating film, and this coating film was dried. Thereafter, the second positive electrode mixture slurry was applied on a portion where the first coating film was absent to form a second coating film, and this coating film was dried. In this time, the first and second positive electrode mixture slurries were applied so that the first and second coating films were alternately formed in a longitudinal direction of the positive electrode core, that is, so as to form the stripe shape as illustrated in FIG. 2. Note that the first coating film was to be a first region of a positive electrode mixture layer, and the second coating film was to be a second region of the positive electrode mixture layer. In this Example, a ratio between a width of the first region and a width of the second region was adjusted to 75:25. An average value of the widths of the first regions was 7.5 mm, and an average value of the widths of the second regions was 2.5 mm.

Then, the coating films (the positive electrode mixture layer) was rolled by using a roller so that a mixture density of the first region was 3.4 g/cc and a mixture density of the second region was 3.3 g/cc, and the positive electrode core was cut to a predetermined electrode size to obtain a positive electrode in which the positive electrode mixture layer was formed on both the surfaces of the positive electrode core. Note that an exposed portion where the surface of the positive electrode core was exposed was provided at a part of the positive electrode. A porosity of the first region in the positive electrode mixture layer measured by the aforementioned method was 17%, and a porosity of the second region was 21%. A BET specific surface area of the first region was 1.9 m²/g, and a BET specific surface area of the second region was 2.3 m²/g.

### [Production of Negative Electrode]

As a negative electrode active material, natural graphite and a silicon-containing material (a composite material in which fine Si phases were dispersed in a silicon oxide phase) were mixed at a mass ratio of 98:2 to be use. The negative electrode active material, sodium carboxymethylcellulose (CMC-Na), and a dispersion of styrene-butadiene rubber (SBR) were mixed at a solid-content mass ratio of 100:1:1, and water was used as a dispersion medium to prepare a negative electrode mixture slurry. This negative electrode mixture slurry was applied on both surfaces of a negative electrode core composed of copper foil, the coating film was dried, then the coating film was rolled by using a roller, and the negative electrode core was cut to a predetermined electrode size to obtain a negative electrode in which a negative electrode mixture layer was formed on both the surfaces of the negative electrode core. Note that an exposed portion where the surface of the negative electrode core was exposed was provided at a part of the negative electrode.

### [Preparation of Non-Aqueous Electrolyte Liquid]

Into a mixed solvent in which ethylene carbonate (EC), methyl ethyl carbonate (MEC), and dimethyl carbonate (DMC) were mixed at a volume ratio (25 °C) of 3:3:4, LiPF was dissolved at a concentration of 1.2 mol/L to prepare a non-aqueous electrolyte liquid.

### [Production of Test Cell (Non-Aqueous Electrolyte Secondary Battery)]

An aluminum lead was attached to the exposed portion of the above positive electrode, and a nickel lead was attached to the exposed portion of the above negative electrode. The positive electrode and the negative electrode were spirally wound via a separator made of a polyolefin to produce a wound electrode assembly. This electrode assembly was housed in a bottomed cylindrical exterior housing can. The above non-aqueous electrolyte liquid was injected thereinto, and then an opening portion of the exterior housing can was sealed with a sealing assembly to obtain a test cell.

### Example 2

A test cell was produced in the same manner as in Example 1 except that the ratio of the width of the first region and the width of the second region in the positive electrode mixture layer was changed to 25:75.

### Example 3

A test cell was produced in the same manner as in Example 1 except that the ratio of the width of the first region and the width of the second region in the positive electrode mixture layer was changed to 50:50.

### Example 4

A test cell was produced in the same manner as in Example 1 except that the ratio of the width of the first region and the width of the second region in the positive electrode mixture layer was changed to 90:10.

### Example 5

A test cell was produced in the same manner as in Example 1 except that the first coating film and the second coating film were separately rolled, and the second coating film was rolled so that the mixture density of the second region was 3.1 g/cc.

### Example 6

A test cell was produced in the same manner as in Example 1 except that: coating films of the first region and the second region were formed by using only the first positive electrode mixture slurry; and the coating films of the regions were separately rolled, and the coating films of the regions were rolled so that the mixture density of the first region was 3.4 g/cc, and the mixture density of the second region was 3.6 g/cc.

### Comparative Example 1

A test cell was produced in the same manner as in Example 1 except that a positive electrode mixture layer was formed by using only the first positive electrode mixture slurry. A porosity of the positive electrode mixture layer was 17%.

### Comparative Example 2

A test cell was produced in the same manner as in Example 1 except that a positive electrode mixture layer was formed by using only the second positive electrode mixture slurry. A porosity of the positive electrode mixture layer was 20%.

Each of the test cells of Examples and Comparative Examples was subjected to evaluation of a discharge capacity (an initial discharge capacity per unit mass of the positive electrode active material), high-speed charge performance (permeability of the electrolyte liquid), and cycle characteristics (a capacity retention after a cycle test) by the following methods. Table 1 shows the evaluation results. The high-speed charge performance shown in Table 1 is a value relative to the evaluation result of the positive electrode in Comparative Example 1 being 100, and a smaller value thereof means more excellent high-speed charge performance.

### [Evaluation of Discharge Capacity]

Under a temperature environment of 25 °C, the test cell was charged at a constant current of 0.3. It until a battery voltage reached 4.2 V, and then charged at a constant voltage of 4.2 V until a current value reached 0.02 It. Thereafter, the test cell was discharged at a constant current of 0.5. It until the battery voltage reached 2.5 V, and the discharge capacity was determined.

### [Evaluation of High-Speed Charge Performance]

Ethylene carbonate (EC) was dropped with 3 μm on the surface of the positive electrode mixture layer, and a time (a permeation time) until EC permeated the inside from the mixture layer surface to disappear was measured. A case where this permeation time is shorter means more excellent permeability of the electrolyte liquid in the positive electrode mixture layer. The permeability of the electrolyte liquid closely relates to the high-speed charge performance of the battery, and more excellent permeability increases the high-speed charge performance.

### [Evaluation of Cycle Characteristics]

Under a temperature environment of 25 °C, the test cell was charged at a constant current of 0.3. It until a battery voltage reached 4.2 V, and then charged at a constant voltage of 4.2 V until a current value reached 0.02 It. Thereafter, the test cell was discharged at a constant current of 0.5. It until the battery voltage reached 2.5 V. This charge and discharge was specified as one cycle, and 400 cycles were performed. A discharge capacity at the 1st cycle and a discharge capacity at the 300th cycle were determined, and the capacity retention was calculated by the following formula.

Capacity retention (%)=(Discharge capacity at 300th cycle/Discharge capacity at 1st cycle)×100

TABLE 1

| | Positive electrode | | | | | | | | | | |
|---|---|---|---|---|---|---|---|---|---|---|---|
| | Porosity | | Specific surface | | Positive electrode | | Proportion of width | | Evaluation results | | |
| | [%] | | area [m²/g] | | active material | | direction [%] | | Discharge | High-speed | Capacity |
| | First | Second | First | Second | First | Second | First | Second | capacity | charge | retention |
| | region | region | region | region | region | region | region | region | [mAh/g] | property | [%] |
| Example 1 | 17 | 21 | 1.9 | 2.3 | Secondary | Single | 75 | 25 | 198 | 83 | 88 |
| | | | | | particles | particles | | | | | |
| Example 2 | 17 | 21 | 1.9 | 2.3 | Secondary | Single | 25 | 75 | 179 | 83 | 91 |
| | | | | | particles | particles | | | | | |
| Example 3 | 17 | 21 | 1.9 | 2.3 | Secondary | Single | 50 | 50 | 187 | 91 | 90 |
| | | | | | particles | particles | | | | | |
| Example 4 | 17 | 21 | 1.9 | 2.3 | Secondary | Single | 90 | 10 | 204 | 87 | 85 |
| | | | | | particles | particles | | | | | |
| Example 5 | 17 | 27 | 1.9 | 2.9 | Secondary | Single | 75 | 25 | 180 | 77 | 85 |
| | | | | | particles | particles | | | | | |
| Example 6 | 17 | 11 | 1.9 | 1.2 | Secondary | Secondary | 75 | 25 | 206 | 108 | 83 |
| | | | | | particles | particles | | | | | |
| Comparative | 17 | — | 1.9 | — | Secondary | — | 100 | 0 | 208 | 100 | 83 |
| Example 1 | | | | | particles | | | | | | |
| Comparative | 20 | — | 2.3 | — | Single | — | 100 | 0 | 173 | 71 | 95 |
| Example 2 | | | | | particles | | | | | | |

As shown in Table 1, all of the test cells of Examples exhibit good permeability of the electrolyte liquid compared with the test cell of Comparative Example 1. Thus, the test cells of Examples have excellent high-speed charge performance. In addition, all of the test cells of Examples have a high capacity compared with the test cell of Comparative Example 2. Note that the test cell of Comparative Example 1 has a high capacity but poor high-speed charge performance, and the test cell of Comparative Example 2 has excellent high-speed charge performance but a low capacity. From this result, it is understood that the secondary battery having a high capacity and excellent high-speed charge performance may be achieved by providing at least two regions having porosities different from each other in the positive electrode mixture layer and by alternately disposing, for example, the first and second regions in the longitudinal direction of the positive electrode core.

The present disclosure will be further described with the following embodiments.

Constitution 1: A positive electrode for a secondary battery, comprising: a positive electrode core; and a positive electrode mixture layer disposed on the positive electrode core, wherein the positive electrode mixture layer includes a first region and a second region that are alternately disposed in at least one direction of a longitudinal direction and a width direction of the positive electrode core, and a porosity of the second region is greater than a porosity of the first region.

Constitution 2: The positive electrode for a secondary battery according to Constitution 1, wherein a BET specific surface area of the second region is greater than a BET specific surface area of the first region.

Constitution 3: The positive electrode for a secondary battery according to Constitution 1 or 2, wherein the first region and the second region are alternately disposed in the longitudinal direction of the positive electrode core.

Constitution 4: The positive electrode for a secondary battery according to Constitution 3, wherein a length of the first region along the longitudinal direction of the positive electrode core is greater than a length of the second region along the longitudinal direction of the positive electrode core.

Constitution 5: The positive electrode for a secondary battery according to Constitution 3 or 4, wherein the first region and the second region are formed over an entire length of the width direction of the positive electrode core.

Constitution 6: The positive electrode for a secondary battery according to Constitution 1 or 2, wherein at least one of the first region and the second region is disposed in a stripe shape, a lattice shape, a dot shape, or a honeycomb shape in a front view of the positive electrode mixture layer.

Constitution 7: The positive electrode for a secondary battery according to any one of Constitutions 1 to 6, wherein the porosity of the first region is greater than 11%.

Constitution 8: The positive electrode for a secondary battery according to any one of Constitutions 1 to 7, wherein the positive electrode mixture layer includes: a first lithium-metal composite oxide being of secondary particles each formed by aggregation of primary particles having an average particle diameter of greater than or equal to 50 nm and less than or equal to 5 μm; and a second lithium-metal composite oxide being of non-aggregated primary particles, the first region includes a larger amount of the first lithium-metal composite oxide than the second lithium-metal composite oxide, and the second region includes a larger amount of the second lithium-metal composite oxide than the first lithium-metal composite oxide.

Constitution 9: The positive electrode for a secondary battery according to any one of Constitutions 1 to 8, wherein a volume-based median diameter of the lithium-metal composite oxide included in the first region is greater than or equal to 10 μm and less than or equal to 30 μm, and a volume-based median diameter of the lithium-metal composite oxide included in the second region is greater than or equal to 2 pun and less than or equal to 10 μm.

Constitution 10: The positive electrode for a secondary battery according to any one of Constitutions 1 to 9, wherein the positive electrode mixture layer includes a lithium-metal composite oxide, and the lithium-metal composite oxide contains Li, Ni, and Co, and contains at least one of Mn and Al, and a proportion of Ni relative to a total number of moles of metal elements excluding Li is greater than or equal to 80 mol %.

Constitution 11: A secondary battery, comprising: the positive electrode for a secondary battery according to any one of Constitutions 1 to 10; a negative electrode; and an electrolyte.

### REFERENCE SIGNS LIST

10 Cylindrical battery, 11 Positive electrode, 12 Negative electrode, 13 Separator, 14 Electrode assembly, 16 Exterior housing can, 17 Sealing assembly, 18, 19 Insulating plate, 20 Positive electrode lead, 21 Negative electrode lead, 22 Grooved portion, 23 Internal terminal plate, 24 Lower vent member, 25 Insulating member, 26 Upper vent member, 27 Cap, 28 Gasket, 30 Positive electrode core, 31 Positive electrode mixture layer, 35 First region, 36 Second region, 40 Negative electrode core, 41 Negative electrode mixture layer

1. A positive electrode for a secondary battery, comprising:
a positive electrode core; and
a positive electrode mixture layer disposed on the positive electrode core, wherein
the positive electrode mixture layer includes a first region and a second region that are alternately disposed in at least one direction of a longitudinal direction and a width direction of the positive electrode core, and
a porosity of the second region is greater than a porosity of the first region.

2. The positive electrode for a secondary battery according to claim 1, wherein a BET specific surface area of the second region is greater than a BET specific surface area of the first region.

3. The positive electrode for a secondary battery according to claim 1, wherein the first region and the second region are alternately disposed in the longitudinal direction of the positive electrode core.

4. The positive electrode for a secondary battery according to claim 3, wherein a length of the first region along the longitudinal direction of the positive electrode core is greater than a length of the second region along the longitudinal direction of the positive electrode core.

5. The positive electrode for a secondary battery according to claim 3, wherein the first region and the second region are formed over an entire length of the width direction of the positive electrode core.

6. The positive electrode for a secondary battery according to claim 1, wherein at least one of the first region and the second region is disposed in a stripe shape, a lattice shape, a dot shape, or a honeycomb shape in a front view of the positive electrode mixture layer.

7. The positive electrode for a secondary battery according to claim 1, wherein the porosity of the first region is greater than 11%.

8. The positive electrode for a secondary battery according to claim 1, wherein
the positive electrode mixture layer includes: a first lithium-metal composite oxide being of secondary particles each formed by aggregation of primary particles having an average particle diameter of greater than or equal to 50 nm and less than or equal to 5 μm; and a second lithium-metal composite oxide being of non-aggregated primary particles,
the first region includes a larger amount of the first lithium-metal composite oxide than the second lithium-metal composite oxide, and
the second region includes a larger amount of the second lithium-metal composite oxide than the first lithium-metal composite oxide.

9. The positive electrode for a secondary battery according to claim 1, wherein
a volume-based median diameter of the lithium-metal composite oxide included in the first region is greater than or equal to 10 μm and less than or equal to 30 jun, and
a volume-based median diameter of the lithium-metal composite oxide included in the second region is greater than or equal to 2 μm and less than or equal to 10 μm.

10. The positive electrode for a secondary battery according to claim 1, wherein
the positive electrode mixture layer includes a lithium-metal composite oxide, and
the lithium-metal composite oxide contains Li, Ni, and Co, and contains at least one of Mn and Al, and a proportion of Ni relative to a total number of moles of metal elements excluding Li is greater than or equal to 80 mol %.

11. A secondary battery, comprising:
the positive electrode for a secondary battery according to claim 1;
a negative electrode; and
an electrolyte.
